(19) United States
(12) Patent Application Publication
(10) Pub. No.: US 2014/0253280 A1
(43) Pub. Date: Sep. 11, 2014

(54) Repeatable Fuse for Preventing Over-Current

(71) Applicant: MS Techvision Co., Ltd., Gyeonggi-do (KR)

(72) Inventors: Duk Hee Kim, Gyeonggi-do (KR); Ha Young Park, Gangbuk-gu (KR)

(21) Appl. No.: 14/352,748

(22) PCT Filed: Oct. 30, 2012
(86) PCT No.: PCT/KR2012/009000

§ 371 Date: Apr. 18, 2014

(30) Foreign Application Priority Data
Oct. 31, 2011 (KR) 10-2011-0111821

(51) Int. Cl. H01H 37/46

(52) U.S. Cl. CPC H01H 37/46
USPC 337/139

(57) ABSTRACT

Provided is a reusable fuse having an over-current prevention function. When an over-current that is greater than a reference level is supplied to the reusable fuse and temperature of a positive temperature coefficient thermistor is higher than a specific critical temperature, then an electric resistance of the positive temperature coefficient thermistor increases, a main spring is extended, and thus the spindle is moved toward a side of a housing due to a tensile strength of the main spring and is electrically disconnected from a first lead terminal, thereby continuously blocking flow of current between a second lead terminal and the first lead terminal. When the over-current subsides, then the positive temperature coefficient thermistor is cooled, the tensile strength of the main spring decreases, and thus the spindle is moved toward another side of the housing to be electrically connected to the first lead terminal, thereby allowing the reusable fuse to return to a normal operation state.

### CROSS-REFERENCE TO RELATED APPLICATION

This application claims priority to and the benefit of Korean Patent Application No. 10-2011-0111821, filed on Oct. 31, 2012, the disclosure of which is incorporated herein by reference in its entirety.

### BACKGROUND

1. Field of the Invention

The present invention relates to a repeatable fuse including a positive temperature coefficient thermistor, and more particularly, to a repeatable fuse having an over-current protection function, in which when a positive temperature coefficient thermistor self-heats to a specific critical temperature or more, due to an over-current, an electric resistance of the positive temperature coefficient thermistor sharply increases to continuously block the flow of current therethrough, thereby continuously shutting off power supply to the repeatable fuse and when the over-current subsides, the positive temperature coefficient thermistor is cooled to allow normal flow of current therethrough.

2. Discussion of Related Art

In general, accidents are very likely to occur in all of various types of electric/electronic products using electric power since they may be overheated due to an abnormal over-current occurring in a circuit therein or an external overheating cause. Conventionally, in order to prevent this problem, a disposable fuse formed of a material that is fused and cut off by heat generated when over-current flows therethrough is used. Although the disposable fuse is inexpensive, the disposable fuse cannot be reused and should be replaced with a new fuse after the disposable fuse is used, thereby increasing costs for the replacement. To solve this problem, a bimetal thermal switch manufactured by joining different types of metal plates having different thermal expansion coefficients has been used instead of the disposable fuse. However, the bimetal thermal switch simply acts as a contact point, has a high variation in operation rates according to temperature, and requires an additional device, e.g., a limit switch.

On the other hand, as surface mounting is performed on a printed circuit board (PCB), a fuse on which surface mounting may be performed is required. However, surface mounting cannot be performed on a conventional disposable fuse since the conventional disposable fuse is fused at a temperature of about 270° C. or high at which soldering is performed during a surface mounting process. Although use of the bimetal thermal switch may avoid this problem, the bimetal thermal switch has a large size and is likely to deteriorate at a temperature of about 270° C. or high at which soldering is performed. Thus, surface mounting cannot be performed on the bimetal thermal switch either.

To solve this problem, a repeatable fuse formed of an elastic member that can be continuously used and on which surface mounting may be performed, e.g., an elastic member formed of a shape-memory alloy, has been introduced. The repeatable fuse has high reliability, since power cut-off may be automatically executed and canceled and the elastic member formed of a shape-memory alloy has a low temperature deviation.

However, if, under unstable current or voltage circumstances, the repeatable fuse repeatedly performs a process of executing power cut-off and canceling the power cut-off in a state in which a circuit and the like are not sufficiently cooled, then the repeatable fuse may malfunction or circuits included in an electric/electronic product may be overheated. In this case, fire or failure may occur in the electric/electronic product.

### PRIOR ART DOCUMENTS

### Patent Documents

Korean Registered Patent No. 10-1017995
Korean Registered Patent No. 10-0912215
Korean Registered Patent No. 10-1017996

### SUMMARY OF THE INVENTION

The present invention is directed to a repeatable fuse having an over-current protection function, in which, when a positive temperature coefficient thermistor self-heats to a specific critical temperature or more, due to over-current, an electric resistance of the positive temperature coefficient thermistor sharply increases to continuously block the flow of current therethrough, thereby continuously shutting off power supply to the repeatable fuse, and when the over-current subsides, the positive temperature coefficient thermistor is cooled and allows normal flow of current therethrough.

According to an aspect of the present invention, there is provided a repeatable fuse having an over-current prevention function, the repeatable fuse including a housing having an inner space; a first lead terminal disposed at an inner side of the housing; a second lead terminal disposed at another inner side of the housing; a spindle disposed in the housing to be electrically disconnected from or electrically connected to the first lead terminal and to be electrically connected to the second lead terminal; a main spring disposed between the first lead terminal and the spindle, and configured to electrically disconnect the first lead terminal and the spindle from each other; a bias spring disposed between the spindle and the second lead terminal and configured to electrically disconnect the first lead terminal and the spindle from each other or to electrically connect the first lead terminal and the spindle to each other; a positive temperature coefficient thermistor inserted into an inner side of the housing, and connected to either the first lead terminal and the housing or the first lead terminal and the main spring. The positive temperature coefficient thermistor includes a positive temperature coefficient element, an electric resistance of which increases when a temperature of the positive temperature coefficient element is higher than a specific critical temperature. If an over-current that is greater than a reference level is supplied to the positive temperature coefficient thermistor and the temperature of the positive temperature coefficient thermistor is thus higher than the specific critical temperature, then the electric resistance of the positive temperature coefficient thermistor increases, the main spring is extended, and the spindle is moved toward the other inner side of the housing due to a tensile strength of the main spring and is thus electrically disconnected from the first lead terminal, thereby continuously blocking flow of current between the second lead terminal and the first lead terminal. If the over-current subsides, then the positive temperature coefficient thermistor is cooled, the tensile strength of the main spring decreases, and the spindle is moved toward the inner side of the housing, is electrically connected to the first lead terminal, and thus returns to the original position.

The positive temperature coefficient thermistor may include a first electrode connected to the first lead terminal; a second electrode connected to the housing; and a positive temperature coefficient element disposed between the first electrode and the second electrode, wherein an electric resistance of the positive temperature coefficient element increases when a temperature of the positive temperature coefficient element is higher than the specific critical temperature.

The positive temperature coefficient thermistor may include a first electrode connected to the first lead terminal; a second electrode connected to the housing; a third electrode connected to the main spring; and a positive temperature coefficient element disposed between the first electrode, the second electrode, and the third electrode, wherein an electric resistance of the positive temperature coefficient element increases when a temperature of the positive temperature coefficient element is higher than the specific critical temperature.

The positive temperature coefficient thermistor may include a first electrode connected to the first lead terminal; a third electrode connected to the main spring; and a positive temperature coefficient element disposed between the first electrode and the third electrode, wherein an electric resistance of the positive temperature coefficient element increases when a temperature of the positive temperature coefficient element is higher than the specific critical temperature.

The positive temperature coefficient element may be formed of a barium titanate (BaTiO₃)-based ceramic material.

The positive temperature coefficient element may be formed of a polymer material in which conductive metallic particles are distributed in a polymer matrix.

The positive temperature coefficient element may have a ring structure in which an opening providing a path in which the spindle makes a reciprocal movement is formed at a center. The first electrode may be formed on a front surface of the positive temperature coefficient element. The third electrode may be formed on a rear surface of the positive temperature coefficient element. An insulator may be disposed on side surfaces of the positive temperature coefficient element to prevent a short circuit from occurring between the first electrode and the third electrode.

The repeatable fuse may further include a ceramic block disposed at the inner side of the housing at which the first lead terminal is disposed, configured to cover a portion of a region of the first lead terminal inserted into the inner side of the housing except for a region of the first lead terminal being electrically connected to the spindle, and formed of an insulator to prevent the housing and the first lead terminal from being electrically connected.

The first lead terminal may have a tack-shaped structure including a rod-shaped pin that is elongated and a wide plate type connection unit disposed on an end of the rod-shaped pin. The first electrode may be connected to the connection unit of the first lead terminal, and the third electrode opposite to the first electrode may be connected to the main spring.

The repeatable fuse may further include a ceramic block disposed at the inner side of the housing at which the first lead terminal is disposed, and formed of an insulator to prevent the housing and the first lead terminal from being electrically connected and to fix the first lead terminal. The ceramic block may include a low stepped portion having a gutter or trench shape, on which a portion of the first lead terminal is placed. The first lead terminal may have a structure including a plate type strap unit and a wide plate type connection unit disposed at one end of the strap unit to be easily connected with a plus (+) terminal of a battery. An insulator may be disposed on an upper portion of the first lead terminal placed on the low stepped portion.

The housing may have a rectangular box structure. The positive temperature coefficient element may have a rectangular or ring shape in which an opening providing a path in which the spindle makes a reciprocal movement is formed at a center. The first electrode may be formed on a front surface of the positive temperature coefficient element. The third electrode may be formed on a rear surface of the positive temperature coefficient element. An insulator may be disposed at side surfaces of the positive temperature coefficient element to prevent a short circuit from occurring between the first electrode and the third electrode.

The main spring may be formed of a shape-memory alloy and may be electrically disconnected from the first lead terminal. The bias spring may include a conductive spring. If an over-current that is higher than a reference level is supplied to the main spring and a temperature of the main spring is thus higher than a transition temperature, then a tensile strength of the main spring may be greater than a tensile strength of the bias spring and the spindle may thus be moved toward the second lead terminal to be electrically disconnected from the first lead terminal. If the over-current subsides and the positive temperature coefficient thermistor is cooled or if an external heat source causing overheating is removed, then the tensile strength of the main spring may be less than the tensile strength of the bias spring and the spindle may be moved toward the first lead terminal due to the tensile strength of the bias spring.

According to the present invention, when a positive temperature coefficient thermistor self-heats to a specific critical temperature or more, due to over-current, an electric resistance of the positive temperature coefficient thermistor sharply increases to continuously block the flow of current therethrough, thereby preventing power from being continuously supplied via a repeatable fuse. Thus, fire or failure may be prevented from occurring in an electric/electronic product, caused when a circuit therein is supplied over-current or is over-heated.

When the over-current subsides, the positive temperature coefficient thermistor is cooled to allow normal flow of current therethrough. When the normal flow of current is allowed, a time delay corresponding to a time period in which the positive temperature coefficient thermistor is cooled occurs. Thus, since such a power cut-off state is automatically canceled in a state in which the circuit or the like is sufficiently cooled, failure may be suppressed from occurring in a repeatable fuse and over-heating of a circuit included in an electric/electronic product may be suppressed. Accordingly, the occurrence of fire or failure in the electric/electronic product may be minimized.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIGS. 1 and 2 illustrate a repeatable fuse according to an exemplary embodiment of the present invention;

FIGS. 3 and 4 illustrate positive temperature coefficient thermistors according to exemplary embodiments of the present invention;

FIGS. 5 and 6 illustrate a repeatable fuse according to another exemplary embodiment of the present invention;

FIG. 7 illustrates a positive temperature coefficient thermistor according to another exemplary embodiment of the present invention;

FIG. 8 is an exploded perspective view of a repeatable fuse according to an exemplary embodiment of the present invention;

FIG. 9 is a graph illustrating resistance characteristics of a positive temperature coefficient thermistor according to temperature;

FIG. 10 illustrates a repeatable fuse according to another exemplary embodiment of the present invention;

FIG. 11 illustrates a positive temperature coefficient thermistor according to another exemplary embodiment of the present invention;

FIG. 12 illustrates a housing of a repeatable fuse according to another exemplary embodiment of the present invention; and

FIG. 13 illustrates a first lead terminal, a ceramic block, and a positive temperature coefficient thermistor according to an exemplary embodiment of the present invention.

### DETAILED DESCRIPTION OF EXEMPLARY EMBODIMENTS

According to an aspect of the present invention, there is provided a repeatable fuse having an over-current prevention function, the repeatable fuse including a housing having an inner space; a first lead terminal disposed at an inner side of the housing; a second lead terminal disposed at another inner side of the housing; a spindle disposed in the housing to be electrically disconnected from or electrically connected to the first lead terminal and to be electrically connected to the second lead terminal; a main spring disposed between the first lead terminal and the spindle, and configured to electrically disconnect the first lead terminal and the spindle from each other; a bias spring disposed between the spindle and the second lead terminal and configured to electrically disconnect the first lead terminal and the spindle from each other or to electrically connect the first lead terminal and the spindle to each other; a positive temperature coefficient thermistor inserted into an inner side of the housing, and connected to either the first lead terminal and the housing or the first lead terminal and the main spring. The positive temperature coefficient thermistor includes a positive temperature coefficient element, an electric resistance of which increases when a temperature of the positive temperature coefficient element is higher than a specific critical temperature. If an over-current that is greater than a reference level is supplied to the positive temperature coefficient thermistor and the temperature of the positive temperature coefficient thermistor is thus higher than the specific critical temperature, then the electric resistance of the positive temperature coefficient thermistor increases, the main spring is extended, and the spindle is moved toward the other inner side of the housing due to a tensile strength of the main spring and is thus electrically disconnected from the first lead terminal, thereby continuously blocking flow of current between the second lead terminal and the first lead terminal. If the over-current subsides, then the positive temperature coefficient thermistor is cooled, the tensile strength of the main spring decreases, and the spindle is moved toward the inner side of the housing, is electrically connected to the first lead terminal, and thus returns to the original position.

Exemplary embodiments of the present invention will be described in detail below with reference to the accompanying drawings. While the present invention is shown and described in connection with exemplary embodiments thereof, it will be apparent to those skilled in the art that various modifications can be made without departing from the spirit and scope of the invention. Like reference numerals denote like elements throughout the drawings.

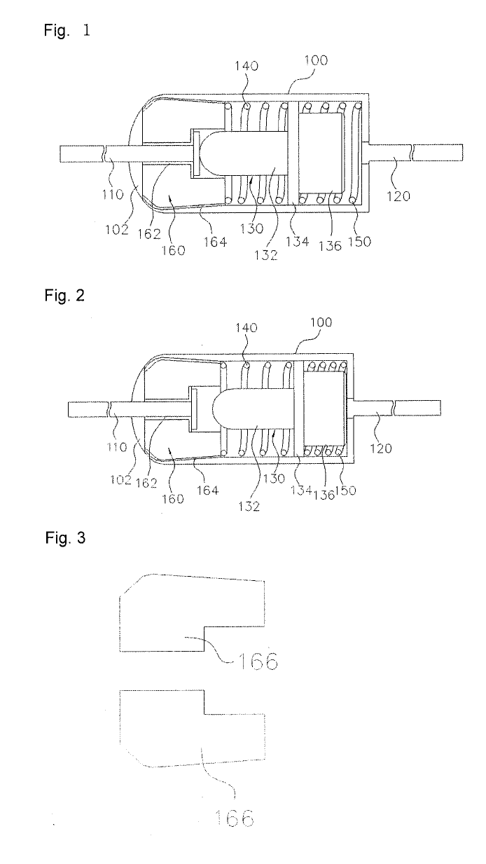

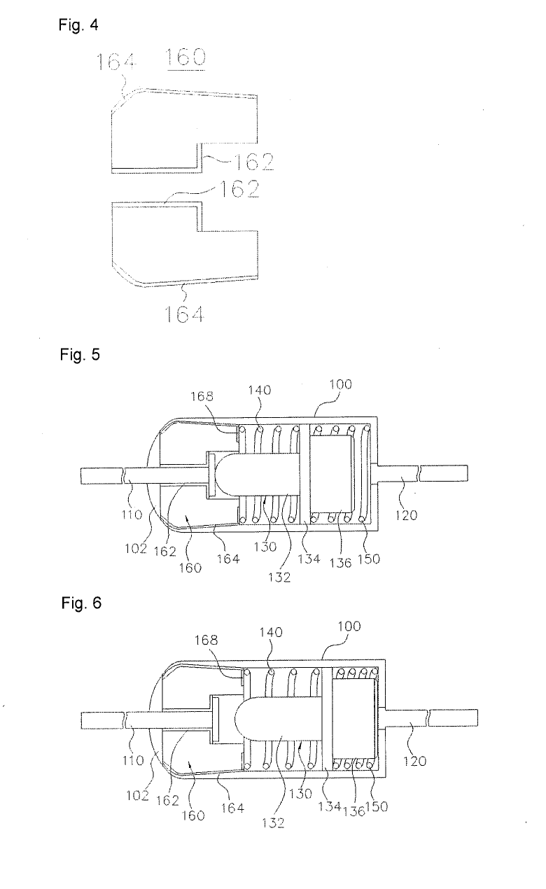

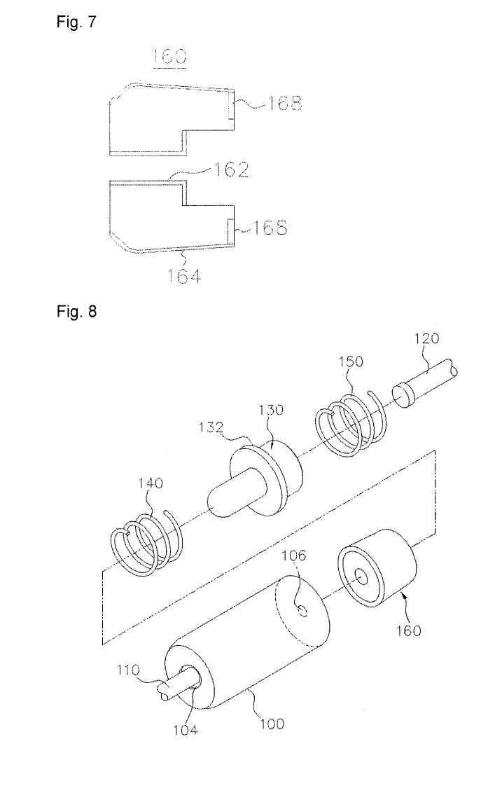

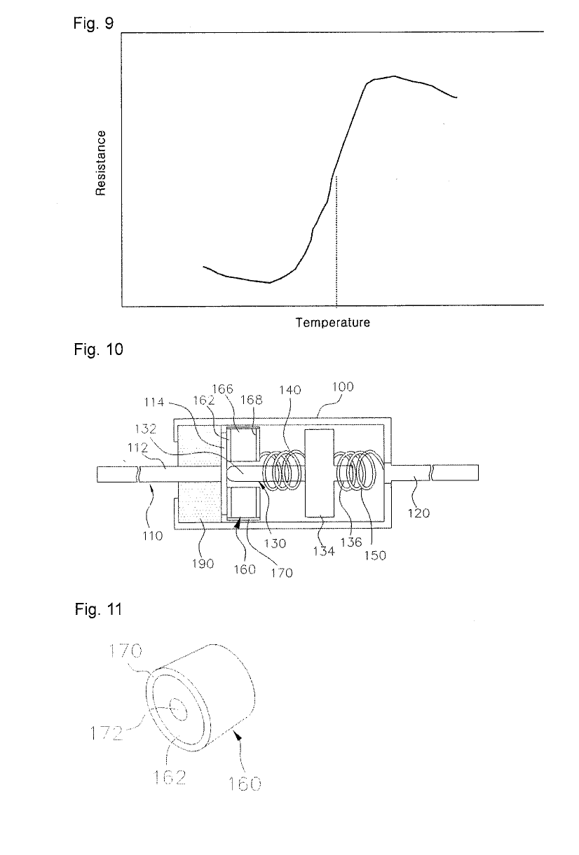

FIGS. 1 and 2 illustrate a repeatable fuse according to an exemplary embodiment of the present invention. FIGS. 3 and 4 illustrate positive temperature coefficient thermistors according to exemplary embodiments of the present invention. FIGS. 5 and 6 illustrate a repeatable fuse according to another exemplary embodiment of the present invention. FIG. 7 illustrates a positive temperature coefficient thermistor according to another exemplary embodiment of the present invention. FIG. 8 is an exploded perspective view of a repeatable fuse according to an exemplary embodiment of the present invention. FIG. 9 is a graph illustrating resistance characteristics of a positive temperature coefficient thermistor according to temperature.

Referring to FIGS. 1 to 9, a repeatable fuse according to an exemplary embodiment includes a housing 100 having an inner space, a first lead terminal 110, a second lead terminal 120, a spindle 130, a main spring 140, a bias spring 150, and a positive temperature coefficient thermistor 160. The first lead terminal 110 is disposed at an inner side of the housing 100. The second lead terminal 120 is disposed at another inner side of the housing 100. The spindle 130 is disposed in the housing 100, is electrically disconnected from or electrically connected to the first lead terminal 110, and is electrically connected from the second lead terminal 120. The main spring 140 is an elastic member installed in the housing 100, is connected to the spindle 130, and electrically disconnects the first lead terminal 110 and the spindle 130 from each other or electrically connects the first lead terminal 110 and the spindle 130 to each other. The positive temperature coefficient thermistor 160 is inserted into an inner side of the housing 100 to be connected to either the first lead terminal 110 and the housing 100 or the first lead terminal 110 and the main spring 140. The repeatable fuse may further include a nonconductive waterproof adhesive unit 102 that fixes the first lead terminal 110 and that seals the inside of the housing 100.

The housing 100 has a box shape that has an inner space and extends in a lengthwise direction thereof, and accommodates and protects the spindle 130, the main spring 140, and the bias spring 150 therein. The positive temperature coefficient thermistor 160 is disposed at an inner side of the housing 100 to be connected to either the first lead terminal 110 and the housing 100 or the first lead terminal 110 and the main spring 140. A first opening 104 and a second opening 106 are formed in one side surface and another side surface of the housing 100, respectively. The first lead terminal 110 may be inserted into the first opening 104 formed in one side surface of the housing 100. The second lead terminal 120 may be inserted into the second opening 104 formed in another side surface of the housing 100. The housing 100 may be formed of an insulating material or a conductive material. Here, a case in which the housing 100 is formed of a conductive material will be described, since the housing 100 of the repeatable fuse according to the present embodiment may be electrically connected to the second lead terminal 120 while contacting the second lead terminal 120. Alternatively, according to another exemplary embodiment, the housing 100 may be formed of a nonconductive material. The housing 100 may have any of various shapes, e.g., a circular box shape, an oval box shape, and a polygonal box shape, since a cross section of the housing 100 perpendicular to the lengthwise direction thereof may have a circular, oval, or polygonal shape. In the present embodiment, the housing 100 is illustrated as a cylindrical type housing having a circular cross section perpendicular to the lengthwise direction.

The first lead terminal 110 is an electrically connecting unit that, for example, delivers current supplied from the second lead terminal 120 to an electric/electronic element (not shown), and is formed of a conductive material. The first lead terminal 110 is disposed at the inner side of the housing 100. In the present embodiment, the first lead terminal 110 is disposed at one end of the housing 100 having a circular box shape. In this case, the first lead terminal 110 may be inserted into the housing 100 while passing through a side of the housing 100, but the present invention is not limited thereto and the first lead terminal 110 may be disposed apart from a side of the housing 100. In other words, the location of the first lead terminal 110 in the housing 100 is not limited, provided the spindle 130 may be moved to be connected to or disconnected from the first lead terminal 110.

The second lead terminal 120 is a unit to which power is supplied from the outside or that is connected to a power source, and is formed of a conductive material. The second lead terminal 120 is disposed a predetermined distance from the first lead terminal 110. In the present embodiment, the second lead terminal 120 is disposed at an end of the housing 100 opposite to an end of the housing 100 having a circular box shape at which the first lead terminal 110 is disposed. The second lead terminal 120 is electrically connected to the main spring 140 or the bias spring 150 via the housing 100 or an additional connecting member (not shown), and is thus electrically connected to the spindle 130 via the main spring 140 or the bias spring 150. For example, when the housing 100 is formed of a conductive material and the main spring 140 or the bias spring 150 contacts an inner surface of the housing 100, the second lead terminal 120 is electrically connected to the main spring 140 or the bias spring 150 via the housing 100. Also, the main spring 140 or the bias spring 150 may be connected to the spindle 130 to be electrically connected to the spindle 130. In the present embodiment, the second lead terminal 120 has a cylindrical shape, but the present invention is not limited thereto and the second lead terminal 120 may have any of other various shapes allowing the second lead terminal 120 to be electrically connected to another unit.

The first lead terminal 110 is electrically connected to or electrically disconnected from the second lead terminal 120 via the spindle 130. Since the first lead terminal 110 is electrically connected to the second lead terminal 120 via the spindle 130, the first lead terminal 110 is disposed to be insulated from the housing 100 that is electrically connected to the second lead terminal 120. To this end, the inner side of the housing 100 at which the first lead terminal 110 is disposed may have an opening shape so that the housing 100 and the first lead terminal 110 may be disposed apart from each other, or an inner circumferential surface of the housing 100 through which the first lead terminal 110 passes may be coated with an insulating material. Otherwise, the first lead terminal 110 may be insulated from the housing 100 by disposing the positive temperature coefficient thermistor 160 between the housing 100 and the first lead terminal 110.

The positive temperature coefficient thermistor 160 is disposed at the inner side of the housing 100 at which the first lead terminal 110 is disposed. It is effective when a region of the first lead terminal 110 inserted into a side of the housing 100 is partially covered with the positive temperature coefficient thermistor 160. The positive temperature coefficient thermistor 160 may preferably cover a region of the first lead terminal 110 except for a region of the first lead terminal 110 that is electrically connected to the spindle 130. The positive temperature coefficient thermistor 160 may be formed to correspond to an inner side region of the housing 100 so that the positive temperature coefficient thermistor 160 may be fixed in the housing 100. In this case, an inner region of the housing 100 into which the positive temperature coefficient thermistor 160 is inserted may have a low stepped portion so that the positive temperature coefficient thermistor 160 may be fixed when the positive temperature coefficient thermistor 160 is inserted into a predetermined position in the housing 100. When the positive temperature coefficient thermistor 160 is installed as described above, it is effective when the first lead terminal 110 inserted into the positive temperature coefficient thermistor 160 also has a low stepped portion so that the first lead terminal 110 may be prevented from being separated from the positive temperature coefficient thermistor 160. In this case, it is effective when the low stepped portion is formed in a direction crossing a lengthwise direction of the first lead terminal 110, e.g., a direction perpendicular to the lengthwise direction of the first lead terminal 110. Alternatively, a part of a region of the first lead terminal 110 that contacts the main spring 140 may protrude in a direction perpendicular to the lengthwise direction thereof. Thus, the first lead terminal 110 may be fixed when it is disposed at the low stepped portion of the positive temperature coefficient thermistor 160.

The positive temperature coefficient thermistor 160 is a thermally sensitive resistor having a positive temperature coefficient (PTC), in which a resistance value increases when temperature increases. That is, the positive temperature coefficient thermistor 160 is a resistor, the resistance value of which sharply increases according to a temperature change. Thus, the positive temperature coefficient thermistor 160 exhibits self-heating characteristics.

As illustrated in FIGS. 1, 2, and 4, the positive temperature coefficient thermistor 160 according to an exemplary embodiment of the present invention may include a first electrode 162 connected to the first lead terminal 110, a second electrode 164 connected to the housing 100, and a positive temperature coefficient element 166 having a PTC, in which an electric resistance sharply increases at a specific critical temperature or more. The positive temperature coefficient element 166 may be formed of a ceramic material or a polymer material.

Referring to FIG. 7, a positive temperature coefficient thermistor 160 according to another exemplary embodiment of the present invention may include a first electrode 162 connected to a first lead terminal 110, a second electrode 164 connected to a housing 100, a third electrode 168 connected to a main spring 140, and a positive temperature coefficient element 166 having a PTC, in which an electric resistance sharply increases at a specific critical temperature or more.

Although FIGS. 1 and 2 illustrate the second electrode 164 connected to the housing 100, the second electrode 160 may not be formed when the third electrode 168 is formed to be connected to the main spring 140.

As illustrated in FIG. 9, an electric resistance of the positive temperature coefficient thermistor 160 sharply changes at about a critical temperature (Curie temperature).

The positive temperature coefficient element 166 may be manufactured by mixing BaTiO₃-based ceramic with tin or cerium at a predetermined content, e.g., 2 to 0.01% by weight.

Otherwise, the positive temperature coefficient element 166 may be manufactured by mixing powder of BaTiO₃ and powder of NbO₃ at a ratio of 98 to 99.95% by weight and 2 to 0.05% by weight, forming the resulting mixture into a desired shape of a positive temperature coefficient thermistor, and then baking the resulting mixture at about 1100 to 1500° C. for 1 to 12 hours.

Otherwise, the positive temperature coefficient element 166 may be manufactured by mixing powder of BaTiO₃, powder of NbO₃, and powder of Nb₂O₅, for example, at a ratio of 98 to 99.95% by weight, 2 to 0.05% by weight, and 0.5 to 0.01% by weight, forming the resulting mixture into a desired shape of a positive temperature coefficient thermistor, and then baking the resulting mixture at 1100 to 1500° C. for 1 to 12 hours.

As another example, the positive temperature coefficient element 166 may be formed of a polymer material in which conductive metallic particles, for example, nickel (Ni) particles having conductive properties, are included in a polymer matrix.

FIG. 9 illustrates resistance characteristics of a positive temperature coefficient thermistor according to temperature. In general, electric resistances of positive temperature coefficient thermistors sharply increase at 80 to 150° C. If a repeatable fuse includes such a positive temperature coefficient thermistor, then an electric resistance of the positive temperature coefficient thermistor sharply increases when the temperature of the positive temperature coefficient thermistor increases to 80 to 150° C., which are critical temperatures due to an over-current, thereby preventing current from flowing therethrough. Unless the temperature of the positive temperature coefficient thermistor is lowered to be less than the critical temperatures, the flow of current via the positive temperature coefficient thermistor may be continuously blocked.

The spindle 130 is means for electrically connecting the first and second lead terminals 110 and 120 to each other or electrically disconnecting the first and second lead terminals 110 and 120 from each other, and is disposed in the housing 100. The spindle 130 may include a first connection portion 132 connected to the first lead terminal 110, a support unit 134, and a second connection unit 136 connected to the second lead terminal 120. Similar to the housing 100 extending in the lengthwise direction thereof, the spindle 130 may be manufactured in the form of a shaft extending in a lengthwise direction thereof. A plane of the spindle 130 perpendicular to the lengthwise direction thereof may have a circular shape, an oval shape, or a polygonal shape, and may preferably be formed to be the same as the plane of the housing 100. In the present embodiment, the spindle 130 is formed to have a piston shape along the housing 100 having the cylindrical shape. The spindle 130 may be electrically connected to the first lead terminal 110 via the main spring 140. To this end, the spindle 130 may be formed of a conductive material. Owing to elastic movements of the main spring 140 and the bias spring 150, the spindle 130 makes a reciprocating movement within the housing 100 in the lengthwise direction to be electrically connected to or electrically disconnected from the first lead terminal 110. Thus, when the spindle 130 is electrically connected to or electrically disconnected from the first lead terminal 110, the first lead terminal 110 and the second lead terminal 120 are electrically connected to or electrically disconnected from each other. The support unit 134 capable of supporting the main spring 140 or the bias spring 150 is formed on at least a portion of a side surface of the spindle 130 to be connected to the main spring 140 or the bias spring 150. The support unit 134 protrudes from a side surface of the spindle 130 in a direction perpendicular to a shaft direction of the spindle 130. The support unit 134 may be continuously or discontinuously formed around the side surface of the spindle 130. In other words, the support unit 134 may have any of various shapes, provided the spindle 130 is connected to the main spring 140 or the bias spring 150.

The main spring 140 and the bias spring 150 are means that electrically connect to or electrically disconnected from the first lead terminal 110 and the spindle 130 to each other. The main spring 140 and the bias spring 150 may be disposed in the housing 100 such that they are extended or compressed in the lengthwise direction of the housing 100. The main spring 140 is disposed at one inner side of the housing 100. In the present embodiment, the main spring 140 is connected to the positive temperature coefficient thermistor 160 in the housing 100. The bias spring 150 is disposed at another inner side of the housing 100 opposite to the inner side of the housing 100 at which the main spring 140 is disposed with respect to the spindle 130. In this case, the bias spring 150 is connected to the spindle 130 or is connected to the support 134 of the spindle 130 to be electrically connected to the spindle 130.

In detail, the main spring 140 electrically disconnects the first lead terminal 110 and the spindle 130 from each other, and may be disposed between the first lead terminal 110 and the spindle 130. In this case, the main spring 140 may be disposed at a side of the spindle 130, and preferably, between the positive temperature coefficient thermistor 160 and the spindle 130. Also, the main spring 140 may be disposed in a compressed state between the positive temperature coefficient thermistor 160 and the spindle 130. Specifically, in the repeatable fuse according to the present embodiment, when the main spring 140 is compressed, the first lead terminal 110 and the spindle 130 contact each other. When the main spring 140 is extended, the first lead terminal 110 and the spindle 130 may be electrically disconnected from each other. To this end, according to an exemplary embodiment of the present invention, the main spring 140 is formed of a shape-memory alloy that deforms at a transition temperature or less and returns to the original shape at more than the transition temperature, so that the main spring 140 may be extended when heat is applied to the compressed main spring 140. The main spring 140 may be formed of either nitinol that is an alloy of titanium (Ti) and nickel (Ni) or an alloy of copper (Cu), zinc (Zn), and aluminum (Al). The main spring 140 may be electrically connected to the spindle 130 and may be electrically disconnected from the first lead terminal 110.

The bias spring 150 electrically disconnects the first lead terminal 110 and the spindle 130 from each other, together with the main spring 140, and may be formed to contact a side of the spindle 130 opposite to a side of the spindle 130 that the main spring 140 contacts. In this case, the bias spring 150 may be formed of a general metallic material, e.g., stainless steel, unlike the main spring 140 formed of a shape-memory alloy. For example, a main body of the bias spring 150 may be formed of stainless steel and then plated with silver. That is, the bias spring 150 should provide a certain tensile strength, and silver is plated onto the bias spring 150 to a predetermined thickness so as to help the flow of current through the bias spring 150. Stable current flows through the bias spring 150 owing to the metallic conductivity and the silver-plating of the bias spring 150 when a voltage and a current supplied to the bias spring 150 are maintained constant, but the temperature of the bias spring 150 increases when an over-voltage or an over-current is supplied thereto. As described above, the bias spring 150 is placed in a tensile state, similar to a general spring, at the opposite side of the spindle 130 so as to pressurize the spindle 130 to maintain contact with the first lead terminal 110. When the main spring 140 is extended, the bias spring 150 may be compressed to electrically disconnect the first lead terminal 110 and the spindle 130 from each other.

In the repeatable fuse having a structure as described above according to an exemplary embodiment of the present invention, if a normal current or voltage that is less than or equal to a reference level is supplied to the first lead terminal 110 and the second lead terminal 120, then a tensile stress is applied to the bias spring 150 and the main spring 140 is kept compressed due to a tensile strength of the extended bias spring 150, as illustrated in FIGS. 1 and 5. Thus, the first lead terminal 110 contacts the first connection portion 132 of the spindle 130, and is electrically connected to the second lead terminal 120 via the bias spring 150 contacting the opposite side of the spindle 130 and the housing 100 contacting the bias spring 150.

In the repeatable fuse according to an exemplary embodiment of the present invention, a high current is supplied to the bias spring 150 when abnormal power, e.g., a high current or voltage that is greater than a reference level, is supplied to the first lead terminal 110 and the second lead terminal 120. When a high current is supplied to the bias spring 150, the temperature of the bias spring 150 increases due to a resistance value thereof, thereby increasing an inner temperature of the housing 100. Also, when an electric heating appliance or an electric instrument is overheated, the temperature of the main spring 140 formed of a shape-memory alloy increases to change the main spring 140 into a tensile state. That is, as illustrated in FIGS. 2 and 6, when the main spring 140 is changed into the tensile state, the spindle 130 is pressurized in a direction in which the bias spring 150 is disposed due to the tensile strength of the main spring 140. Thus, the bias spring 150 is compressed. Also, when a tensile stress is applied to the main spring 140, the spindle 130 is moved to electrically disconnect the first lead terminal 110 and the spindle 130 from each other. As a result, the first lead terminal 110 and the second lead terminal 120 are electrically disconnected to not allow current to flow between the first lead terminal 110 and the second lead terminal 120. To this end, the tensile strength of the main spring 140 may be lower than the tensile strength of the bias spring 150 at a transition (transformation) temperature or less, and may be higher than the tensile strength of the bias spring 150 at more than the transition (transformation) temperature.

Although a case in which the main spring 140 is formed of a shape-memory alloy has been described above, the bias spring 150 may be formed of the shape-memory alloy and the main spring 140 may be formed of a general metallic material, e.g., stainless steel.

In the present embodiment, the repeatable fuse is manufactured using the main spring 140 and the bias spring 150 in the form of coils as elastic members, but the present invention is not limited thereto and the main spring 140 and/or the bias spring 150 may be any of other types of springs, e.g., leaf springs.

The repeatable fuse described above is merely an exemplary embodiment of the present invention, in which, when the temperature of the positive temperature coefficient thermistor 160 increases to a specific critical temperature or more, due to over-current, an electric resistance of the positive temperature coefficient thermistor 160 sharply increases to continuously block the flow of current therethrough, thereby continuously shutting off power supply to the repeatable fuse, and when the over-current subsides, the positive temperature coefficient thermistor 160 is cooled and allows normal flow of current therethrough.

In an exemplary embodiment of the present invention, the positive temperature coefficient thermistor 160 is formed of a ceramic material or a polymer material, an electric resistance of which becomes higher as the temperature thereof increases and sharply increases particularly at a specific critical temperature or more, thereby continuously blocking the flow of current therethrough. The positive temperature coefficient thermistor 160 is disposed at an inner side of the housing 100 to fix the first lead terminal 110.

The positive temperature coefficient thermistor 160 is formed of a barium titanate (BaTiO₃)-based ceramic or a polymer material, and an electric resistance of the positive temperature coefficient thermistor 160 sharply increases when the temperature thereof increases. That is, the electric resistance of the positive temperature coefficient thermistor 160 does not gradually increase in direct proportion to temperature but sharply increases at a specific critical temperature or more. Thus, when the temperature of the positive temperature coefficient thermistor 160 is maintained constant to be equal to or greater than the specific critical temperature, the positive temperature coefficient thermistor 160 may continuously block the flow of current therethrough. Thus, the temperature of the positive temperature coefficient thermistor 160 is maintained approximately constant regardless of a change in the temperature of the ambient air or a change in a power supply voltage. Accordingly, the positive temperature coefficient thermistor 160 may function as a switch to block the flow of current when an electric resistance thereof changes according to temperature or increases when an over-current flows therethrough.

When an over-current is supplied to the repeatable fuse including the positive temperature coefficient thermistor 160, the temperature of the positive temperature coefficient thermistor 160 increases to apply a tensile stress to the main spring 140 formed of a shape-memory alloy. Then, the main spring 140 to which the tensile stress is applied pressurizes the spindle 130 to be moved to contact the second lead terminal 120. Also, since the main spring 140 is extended, the first lead terminal 110 and the spindle 130 are electrically disconnected from each other. Then, a current path is immediately connected to the positive temperature coefficient thermistor 160 and the temperature of the positive temperature coefficient thermistor 160 sharply increases due to Joule heat. When the temperature of the positive temperature coefficient thermistor 160 sharply increases to a specific critical temperature or more, an electric resistance of the positive temperature coefficient thermistor 160 sharply increases and thus self-heats, thereby continuously applying a tensile stress to the main spring 140 formed of a shape-memory alloy. Accordingly, unless the temperature of the positive temperature coefficient thermistor 160 is lowered to less than the specific critical temperature, the flow of current therethrough may be continuously blocked.

Furthermore, even if the over-current is continuously supplied to the repeatable fuse, the temperature of the positive temperature coefficient thermistor 160 is not lowered to less than the specific critical temperature. Thus, a high electric resistance of the positive temperature coefficient thermistor 160 may be maintained and the positive temperature coefficient thermistor 160 thus generates heat to continuously apply a tensile stress to the main spring 140 formed of a shape-memory alloy. Thus, current does not continuously flow through the positive temperature coefficient thermistor 160. Accordingly, while the first lead terminal 110 and the spindle 130 are electrically disconnected from each other due to the extension of the main spring 140, current may be continuously prevented from flowing through the positive temperature coefficient thermistor 160, thereby preventing power from being supplied via the repeatable fuse. Even if the over-current is continuously supplied to the repeatable fuse including the positive temperature coefficient thermistor 160, the flow of current through the positive temperature coefficient thermistor 160 is continuously blocked, thereby preventing power from being supplied via the repeatable fuse. Accordingly, fire or failure may be prevented from occurring in an electric/electronic product due to overheating of a current or the like therein.

Supply of power via the repeatable fuse is completely blocked unless the bias spring 150 is extended to return the spindle 130 to the original position and the spindle 130 thus contacts the first lead terminal 110. When the over-current subsides, the positive temperature coefficient thermistor 160 is cooled to extend the bias spring 150 and the spindle 130 thus returns to the original position to be electrically connected to the first lead terminal 110. Then, normal flow of current through the positive temperature coefficient thermistor 160 is allowed. A time delay, which is substantially the same as a time period in which the positive temperature coefficient thermistor 160 is cooled, occurs until the normal flow of current is allowed. Accordingly, since a process of automatically canceling such a power cut-off state is performed in a state in which a circuit or the like is sufficiently cooled, failure can be suppressed from occurring in the repeatable fuse and a circuit included in an electric-electronic product may be prevented from being over-heated.

Although it has been described above that a power source is connected to the second lead terminal 120 and an electric/electronic element, e.g., a circuit, is connected to the first lead terminal 110, the power source may be connected to the first lead terminal 110 and the electric/electronic product may be connected to the second lead terminal 120.

Operations of a repeatable fuse will now be described in greater detail.

If normal power is supplied to an electric/electronic product, i.e., when there is no over-current or over-heating of an ambient temperature, then current is normally supplied to the second lead terminal 120, the housing 100, the bias spring 150, the spindle 130, and finally to the first lead terminal 110. Thus, an electric resistance of the repeatable fuse is maintained to be substantially the same as that of a conducting wire, e.g., about several mΩ, thereby enabling the repeatable fuse to operate normally.

During the normal operation of the repeatable fuse, the spindle 130 is electrically connected to the first lead terminal 110 owing to a tensile strength of the bias spring 150 as illustrated in FIGS. 1 and 5. When a current or a voltage that is less than or equal to a reference level is supplied via the second lead terminal 120, current flows through the spindle 130 via the second lead terminal 120. Since the spindle 130 is electrically connected to the first lead terminal 110, the spindle 130 and the first lead terminal 110 form a circuit together, thereby allowing current to flow toward an electric/electronic element.

If an over-current or an over-voltage that is greater than a reference level is supplied to an electric/electronic product, Joule heat is generated due to a resistance value of the bias spring 150 to extend the main spring 140 formed of a shape-memory alloy. Then, the main spring 140 pressurizes the spindle 130 to move the spindle 130 toward the other side of the housing 100. The spindle 130 thus contacts the second lead terminal 120. Since a connection state between the spindle 130 and the second lead terminal 120 is fixed due to the extension of the main spring 140, the spindle 130 is prevented from automatically returning to the original position to be connected to the first lead terminal 110, thereby preventing power from being supplied to the electric/electronic product.

When an over-current suddenly flows through the repeatable fuse, the bias spring 150 is sharply heated by Joule heat due to a resistance value of the bias spring 150, thus operating (expanding) the main spring 140 formed of a shape-memory alloy. Thus, as illustrated in FIGS. 2 and 6, the first lead terminal 110 and the spindle 130 are disconnected to be electrically disconnected from each other. Thus, a current path is connected to the bias spring 150, the spindle 130, the housing 100, and finally to the positive temperature coefficient thermistor 160. In this case, a resistance value of the positive temperature coefficient thermistor 160 ranges from about several tens of mΩ to several Ω and is thus greater than a resistance value of the bias spring 150, i.e., several mΩ. However, since Joule heat is generated due to the over-current, the resistance value of the positive temperature coefficient thermistor 160 increases to several tens of kΩ to several tens of MΩ within several seconds. Thus, the positive temperature coefficient thermistor 160 substantially becomes an insulator, thereby blocking the over-current.

The positive temperature coefficient thermistor 160 continuously self-heats before the over-current is completely blocked and thus maintains an expanded state of the main spring 140 formed of a shape-memory alloy. Thus, unless the over-current subsides, the spindle 130 does not return to the original position and a electrically disconnected state between the first lead terminal 110 and the spindle 130 is continuously maintained, thereby continuously blocking the over-current.

When the over-current subsides and current does not flow through the positive temperature coefficient thermistor 160, the positive temperature coefficient thermistor 160 does not self-heat and is thus naturally cooled. Thus, the tensile strength of the main spring 140 is released and the tensile strength of the bias spring 150 is stronger than that of the main spring 140. Accordingly, the spindle 130 is moved toward the first lead terminal 110 to electrically connect the first lead terminal 110 and the spindle 130 to each other, thereby allowing the repeatable fuse to return to a normal operation state.

When the over-current subsides and the positive temperature coefficient thermistor 160 is thus cooled, the tensile strength of the main spring 140 is weakened to remove a factor that prevents the spindle 130 from returning to the original position. Thus, the spindle 130 returns to the original position due to the tensile strength of the bias spring 150 and is thus connected to the first lead terminal 110, thereby supplying power to the electric/electronic product. When the positive temperature coefficient thermistor 160 is cooled, the main spring 140 formed of a shape-memory alloy is also cooled. When the main spring 140 is cooled, the tensile strength of the main spring 140 decreases and the main spring 140 is compressed again due to the tensile strength of the bias spring 150. Thus, the first lead terminal 110 and the spindle 130 are electrically connected to each other. To this end, the repeatable fuse according to an embodiment of the present invention may be set such that the tensile strength of the main spring 140 is higher than that of the bias spring 150 at more than a transition (transformation) temperature but the tensile strength of the bias spring 150 is higher than that of the main spring 140 when the inner temperature of the housing 100 is lowered to the transition (transformation) temperature of the main spring 140 or less.

In a structure of a repeatable fuse as illustrated in FIGS. 1, 2, 5, and 6, the first to third electrodes 162, 164, and 168 should be formed on a bent surface of the positive temperature coefficient element 166 and are thus not easy to form. Thus, a repeatable fuse as illustrated in FIGS. 10 and 11 is suggested in order to increase the yield and reduce failure rates in forming the first to third electrodes 162, 164, and 168 in consideration of this problem. FIG. 10 illustrates a repeatable fuse according to another exemplary embodiment of the present invention. FIG. 11 illustrates a positive temperature coefficient thermistor according to another exemplary embodiment of the present invention.

Referring to FIGS. 10 and 11, a positive temperature coefficient element 166 is formed in a ring shape having an opening 172. When the positive temperature coefficient element 166 is formed in a ring shape, a first electrode 162 and a third electrode 168 are easy to form, thereby increasing assembly productivity. A first connection portion 132 of a spindle 130 is inserted into the opening 172 formed at a center of the positive temperature coefficient thermistor 160. The first and third electrodes 162 and 168 are formed on both ends of the positive temperature coefficient thermistor 160 having the ring shape. A first lead terminal 110 has a tack-shaped structure including a rod-shaped pin 112 that is elongated and a wide plate type connection plate 114 disposed at one end of the pin 112.

The repeatable fuse further includes a ceramic block (insulator) 190 formed of an insulator and having a ring shape to prevent the housing 100 and the first lead terminal 110 from being electrically connected. An end of the first lead terminal 110 should be processed to be expanded, e.g., in the form of a tack, so that the housing 100 and the first lead terminal 110 may be electrically connected. The first electrode 162 is connected to the connection plate 114 of the first lead terminal 110, and the third electrode 168 disposed opposite to the first electrode 162 is electrically connected to a main spring 140. As illustrated in FIG. 10, an insulator 170 may be coated or deposited onto side surfaces of the positive temperature coefficient thermistor 160 having the ring shape, so that the first and third electrodes 162 and 168 disposed on both ends of the positive temperature coefficient thermistor 160 may be prevented from being short-circuited and may be insulated from the housing 100.

When an over-current is supplied to the repeatable fuse, a bias spring 150 self-heats, and thus the main spring 140 expands to disconnect the first lead terminal 110 and the spindle 130 to be electrically disconnected from each other. Then, a current path is connected to the bias spring 150, the spindle 130, the main spring 140, and the positive temperature coefficient thermistor 160. In this case, the main spring 140 has a low resistance value, e.g., about several hundreds of mΩ, to be substantially the same as that of a conductor. Thus, the main spring 140 delivers current to the positive temperature coefficient thermistor 160. When an over-current is supplied to the repeatable fuse, the positive temperature coefficient thermistor 160 sharply self-heats to continuously maintain the main spring 140 constant at a high temperature, e.g., 110° C. or more. Accordingly, the first lead terminal 110 and the spindle 130 are kept electrically disconnected from each other.

However, if a factor that causes the over-current is removed and the over-current thus subsides, then the positive temperature coefficient thermistor 160 stops self-heating and is cooled, the tensile strength of the main spring 140 decreases, the spindle 130 is moved toward the first lead terminal 110 due to the tensile strength of the bias spring 150, and then the first lead terminal 110 and the spindle 130 return to be electrically connected.

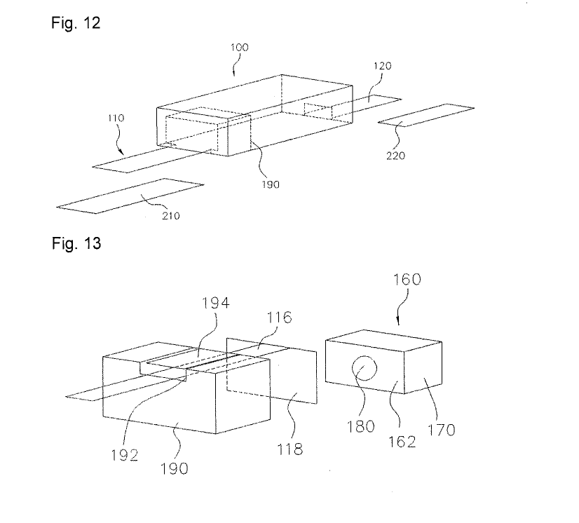

Also, a repeatable fuse employing a lead strap structure as illustrated in FIGS. 12 and 13 is suggested, in which a battery, e.g., a lithium (Li) ion battery, is easily attachable to terminals 210 and 220 of a battery having an over-current/over-heating prevention function. FIG. 12 illustrates a housing 100 of a repeatable fuse according to another exemplary embodiment of the present invention. FIG. 13 illustrates a first lead terminal 110, a ceramic block (insulator) 190, and a positive temperature coefficient thermistor 160.

The housing 100 has a rectangular box-shaped structure having an inner space and extending in a lengthwise direction thereof. Also, the ceramic block 190 formed of an insulator is needed to prevent the housing 100 and the first lead terminal 110 from being electrically connected. The ceramic block 190 is accommodated in the housing 100 at an inner side of the housing 100. The ceramic block 190 may be formed in a rectangular block shape. The ceramic block 190 has a low stepped portion 192 on which a portion of the first lead terminal 110 is placed. The low stepped portion 192 may have a gutter or trench shape.

The first lead terminal 110 may have a plate type strap structure to be easily connected with the plus (+) terminal 210 of the battery. To this end, the first lead terminal 110 has a structure including a plate type strap unit 116 and a wide plate type connection unit 118 disposed on one end of the strap unit 116. Since the first lead terminal 110 includes the strap unit 116 and the connection unit 118 having a wide end, assembly productivity may be improved. A portion of the first lead terminal 110 is placed on the low stepped portion 192. An upper portion of the first lead terminal 110 placed on the low stepped portion 192 may be insulated by coating or depositing an insulator 194 thereon, thereby preventing the first lead terminal 110 and the housing 100 from being electrically connected.

An external shape of the positive temperature coefficient thermistor 160 having an opening 180 at a center thereof may be a rectangular box shape or a ring shape. As described above, a first electrode 162 and a third electrode 168 are easy to form and assembly productivity may be improved by forming the positive temperature coefficient thermistor 160 in a rectangular shape or a ring shape. A spindle 130 is inserted into the opening 180 formed at the center of the positive temperature coefficient thermistor 160. The first and third electrodes 162 and 168 are respectively formed on both ends of the positive temperature coefficient thermistor 160. The first electrode 162 is connected to the first lead terminal 110 and the third electrode 168 opposite to the first electrode 162 is electrically connected to a main spring 140. As illustrated in FIG. 13, side surfaces of the positive temperature coefficient thermistor 160 may be insulated by coating or depositing an insulator 170 thereon, so that the first and third electrodes 162 and 168 on both ends of the positive temperature coefficient thermistor 160 may be prevented from being short-circuited and may be insulated from the housing 100.

The main spring 140, a bias spring 150, and the spindle 130 may be formed in a manner the same as or similar to those illustrated in FIGS. 1 and 2 or FIGS. 5 and 6 and thus will not be described again here.

It will be apparent to those skilled in the art that various modifications can be made to the above-described exemplary embodiments of the present invention without departing from the spirit or scope of the invention. Thus, it is intended that the present invention covers all such modifications provided they come within the scope of the appended claims and their equivalents.

### DESCRIPTION OF DRAWING NUMBERS

| | |
|---|---|
| 100: housing | 102: nonconductive waterproof adhesive unit |
| 104: first opening | 106: second opening |
| 110: first lead terminal | 112: pin |
| 114: connection plate | 116: strap unit |
| 118: connection unit | 120: second lead terminal |
| 130: spindle | 132: first connection portion |
| 134: support unit | 136: second connection unit |
| 134: support unit | 140: main spring |
| 150: bias spring | 160: positive temperature coefficient thermistor |
| 162: first electrode | 164: second electrode |

166: positive temperature coefficient element

| | |
|---|---|
| 168: third electrode | |
| 170: insulator | 172, 180: opening |

### INDUSTRIAL APPLICABILITY

When a positive temperature coefficient thermistor self-heats to a specific critical temperature or more, due to over-current, an electric resistance of the positive temperature coefficient thermistor sharply increases to continuously block the flow of current therethrough, thereby preventing power from being continuously supplied via a repeatable fuse, thus, fire or failure may be prevented from occurring in an electric/electronic product, caused when a circuit therein is supplied over-current or is over-heated, the repeatable fuse is industrially applicable.

1. A reusable comprising:
a housing;
a first lead terminal disposed at an inner side of the housing;
a second lead terminal disposed at another inner side of the housing;
a spindle disposed in the housing to be electrically disconnected from or connected to the first lead terminal and electrically connected to the second lead terminal;
a main spring disposed between the first lead terminal and the spindle, and configured to electrically disconnect the first lead terminal and the spindle from each other;
a bias spring disposed between the spindle and the second lead terminal, and configured to electrically disconnect the first lead terminal and the spindle from each other or electrically connect the first lead terminal and the spindle to each other; and
a positive temperature coefficient thermistor inserted into an inner side of the housing, and connected to either the first lead terminal and the housing or the first lead terminal and the main spring,
wherein the positive temperature coefficient thermistor comprises a positive temperature coefficient element, an electric resistance of which increases when a temperature of the positive temperature coefficient element is higher than a specific critical temperature,
when an over-current that is greater than a reference level is supplied to the positive temperature coefficient thermistor and the temperature of the positive temperature coefficient thermistor is thus higher than the specific critical temperature, then the electric resistance of the positive temperature coefficient thermistor increases, the main spring is extended, and the spindle is moved toward the other inner side of the housing due to a tensile strength of the main spring and is thus electrically disconnected from the first lead terminal, thereby continuously blocking flow of current between the second lead terminal and the first lead terminal, and
when the over-current subsides, then the positive temperature coefficient thermistor is cooled, the tensile strength of the main spring decreases, and the spindle is moved toward the inner side of the housing, is electrically connected to the first lead terminal, and thus returns to the original position.

2. The reusable fuse of claim 1, wherein the positive temperature coefficient thermistor comprises:
a first electrode connected to the first lead terminal;
a second electrode connected to the housing; and
a positive temperature coefficient element disposed between the first electrode and the second electrode, wherein an electric resistance of the positive temperature coefficient element increases when a temperature of the positive temperature coefficient element is higher than the specific critical temperature.

3. The reusable fuse of claim 1, wherein the positive temperature coefficient thermistor comprises:
a first electrode connected to the first lead terminal;
a second electrode connected to the housing;
a third electrode connected to the main spring; and
a positive temperature coefficient element disposed between the first electrode, the second electrode, and the third electrode, wherein an electric resistance of the positive temperature coefficient element increases when a temperature of the positive temperature coefficient element is higher than the specific critical temperature.

4. The reusable fuse of claim 1, wherein the positive temperature coefficient thermistor comprises:
a first electrode connected to the first lead terminal;
a third electrode connected to the main spring; and
a positive temperature coefficient element disposed between the first electrode and the third electrode, wherein an electric resistance of the positive temperature coefficient element increases when a temperature of the positive temperature coefficient element is higher than the specific critical temperature.

5. The reusable fuse of claim 2, wherein the positive temperature coefficient element is formed of a barium titanate (BaTiO₃)-based ceramic material.

6. The reusable fuse of claim 2, wherein the positive temperature coefficient element is formed of a polymer material in which conductive metallic particles are distributed in a polymer matrix.

7. The reusable fuse of claim 4, wherein the positive temperature coefficient element has a ring structure in which an opening providing a path in which the spindle makes a reciprocal movement is formed at a center,
the first electrode is formed on a front surface of the positive temperature coefficient element,
the third electrode is formed on a rear surface of the positive temperature coefficient element, and
an insulator is disposed on side surfaces of the positive temperature coefficient element to prevent a short circuit from occurring between the first electrode and the third electrode.

8. The reusable fuse of claim 7, further comprising a ceramic block disposed at the inner side of the housing at which the first lead terminal is disposed, configured to cover a portion of a region of the first lead terminal inserted into the inner side of the housing except for a region of the first lead terminal being electrically connected to the spindle, and formed of an insulator to prevent the housing and the first lead terminal from being electrically connected.

9. The reusable fuse of claim 7, wherein the first lead terminal has a tack-shaped structure including a rod-shaped pin that is elongated and a wide plate type connection unit disposed on an end of the rod-shaped pin,
the first electrode is connected to the connection unit of the first lead terminal, and the third electrode opposite to the first electrode is connected to the main spring.

10. The reusable fuse of claim 4, further comprising a ceramic block disposed at the inner side of the housing at which the first lead terminal is disposed, and formed of an insulator to prevent the housing and the first lead terminal from being electrically connected and to fix the first lead terminal,
wherein the ceramic block comprises a low stepped portion having a gutter or trench shape, on which a portion of the first lead terminal is placed,
the first lead terminal has a structure including a plate type strap unit and a wide plate type connection unit disposed at one end of the strap unit to be easily connected with a plus (+) terminal of a battery, and
an insulator is disposed on an upper portion of the first lead terminal placed on the low stepped portion.

11. The reusable fuse of claim 10, wherein the housing has a rectangular box structure,
the positive temperature coefficient element has a rectangular or ring shape in which an opening providing a path in which the spindle makes a reciprocal movement is formed at a center,
the first electrode is formed on a front surface of the positive temperature coefficient element,
the third electrode is formed on a rear surface of the positive temperature coefficient element, and
an insulator is disposed at side surfaces of the positive temperature coefficient element to prevent a short circuit from occurring between the first electrode and the third electrode.

12. The reusable fuse of claim 1, wherein the main spring is formed of a shape-memory alloy and is electrically disconnected from the first lead terminal,
the bias spring comprises a conductive spring,
when an over-current that is higher than a reference level is supplied to the main spring and a temperature of the main spring is thus higher than a transition temperature, then a tensile strength of the main spring is greater than a tensile strength of the bias spring and the spindle is thus moved toward the second lead terminal to be electrically disconnected from the first lead terminal, and
when the over-current subsides and the positive temperature coefficient thermistor is cooled or when an external heat source causing overheating is removed, then the tensile strength of the main spring is less than the tensile strength of the bias spring and the spindle is moved toward the first lead terminal due to the tensile strength of the bias spring.
